(19) United States
(12) Patent Application Publication
(10) Pub. No.: US 2001/0052452 A1
(43) Pub. Date: Dec. 20, 2001

(54) Low-profile flip-over contact piece for tactile switch

(76) Inventor: Syuuya Yokobori, Gunma (JP)

Correspondence Address: GALLAGHER & LATHROP, 601 CALIFORNIA ST, SUITE 1111, SAN FRANCISCO, CA, 94108, US

(21) Appl. No.: 09/882,531

(22) Filed: Jun. 15, 2001

(30) Foreign Application Priority Data
Jun. 19, 2000 (JP) 182493

(51) Int. Cl. H01H 5/30

(52) U.S. Cl. 200/406

(57) ABSTRACT

A dome portion of a contact piece has a plurality of circumferentially-spaced-apart marginal portions and a plurality of dome extensions provided between the marginal portions.

### BACKGROUND OF THE INVENTION

The present invention relates to a low-profile, flip-over contact piece for a tactile switch and, more particularly, to a low-profile but relatively long-stroke, flip-over contact piece for a tactile switch.

A description will be given first, with reference to FIGS. 1A, 1B and 2, of a conventional tactile switch disclosed in Japanese Utility Model Registration Gazette 4-8590. FIG. 1A is a longitudinal sectional view taken on the line passing through the center of the tactile switch, FIG. 1B is a magnified view of its principal part, and FIG. 2 is its exploded perspective view.

The tactile switch, indicated generally by 20, has a housing 11 and a cover 12. The housing 11 of a substantially square outside shape has in its top a centrally-disposed circular hole 13 (FIG. 2) and an exposed stationary contact 31 protrusively provided on the inside bottom of the housing 11 and molded integrally therewith at the center thereof. Terminals 31T1 and 31T2 are connected to the central stationary contact 31. On the bottom of the housing 11 there are also molded therewith peripheral stationary contacts 32 and 33 similarly exposed at peripheral portions of the hole 13 diametrically opposite across the central stationary contact 31. Terminals 32T and 33T are connected to the peripheral stationary contacts 32 and 33, respectively.

Reference numeral 4 denotes generally a convex flip-over contact piece, or movable contact piece, which is formed by press working of a springy metal sheet as of phosphor bronze. The convex movable contact piece 4 has a dome or convex portion 41 which snappingly flips over when pushed, and a sharply downturned marginal portion 42 extending from the periphery of the dome portion 41 all around it. The dome portion 41 has at the top thereof an aperture 43.

The movable contact piece 4 is placed in the hole 13 of the housing 11 with the marginal edge 42 held in contact with the peripheral stationary contacts 32 and 33 exposed on the inside bottom of the housing 11. Mounted on the convex movable contact piece 4 placed in the hole 13 is a disk-shaped push button 5. The push button 5 has a relatively thick circular contact disk-shaped portion 51, a flange 53 extending outwardly from its lower marginal edge, and a pair of lugs 54 protruding beyond the side edge of the flange 53 at diametrically opposite positions so as to prevent the push button 5 from turning. The lugs 54 are held in vertically slidable engagement with guide grooves 13R cut in the inside wall of the hole 13. Accordingly, the push button is inhibited from turning in the hole 13 but allowed to slide up and down. Protrusively provided on the underside of the push button 5 centrally thereof is a projection 52, by which the convex movable contact piece 4 is driven at the center thereof.

The switch cover 12 is put on the top of the housing 11 from above the push button 5, with legs 12L of the cover 12 fixedly engaged with side walls of the housing 11. The cover 12 has a centrally disposed opening 12B of a diameter smaller than that of the flange 53 of the push button 5 but larger than the diameter of its central disk-shaped portion 51, and the central disk-shaped portion 51 of the push button 5 protrudes upwardly through the opening 12B.

Upon being pushed, the push button 5 applies downward force through its projection 52 to the movable contact piece 4 to resiliently deform it, and the instant the top of the dome portion 41 passes through its dead point the movable contact piece 4 quickly flips over with a click. When the movable contact piece 4 is resiliently deformed downwardly, air in the space defined by the movable contact piece 4 and the bottom of the hole 13 is discharged through the aperture 43 in the dome portion 41 at the top thereof; hence, the air will not be compressed the cause an increase in the downward force on the dome portion 41. The central disk-shaped portion 51 of the push button 5 slightly protrudes upwardly of the switch cover 12 through its opening 12B. The housing 11 and the cover 12 are molded as a one-piece liquid-tight structure.

The lower edge of the marginal portion 42 of the convex movable contact pieces 4 is always held in contact with the peripheral stationary contacts 32 and 33. In the normal state in which the push button 5 is not being pushed, the movable contact piece 4 keeps its convex form due to the springiness of its own and pushes up the push button 5 through the projection 52, urging the flange 53 against the underside of the switch cover 12 and hence resiliently biasing the push button 5 upward. With the push button 5 thus resiliently biased, the movable contact piece 4 keeps out of contact with the central stationary contact 31, and hence no electric connections are established between the central stationary contact 31 and the peripheral stationary contacts 32 and 33, holding the switch open. That is, no electric connections are made between the terminals 31T1, 31T2 and the terminal 32, or between the terminals 31T1, 31T2 and the terminal 33.

Upon depression of the push button 5, the central portion 41 of the convex movable contact piece 4 is resiliently deformed downward by the projection 52 of the push button 5, and when pressed down beyond its dead point, the central portion 41 of the contact piece 4 snappingly flips over into contact with the central area 30 of the central stationary contact 31. As a result, electric connections are established between the central stationary contact 31 and the peripheral stationary contacts 32 and 33 via the movable contact piece 4, and consequently, electric connections are made between the terminals 31T1, 31T2 and the terminals 32T, 33T.

The outer dimensions of the tactile switch 20 now in practical use are approximately 5 mm in width, 5 mm in depth and 3 mm in thickness at the largest. In such a small tactile switch 20, the diameter φ of the convex movable contact piece 4 is as small as 4 mm or so.

In the conventional movable contact piece 4 described above, even when the actuation force applied to the convex portion 41 by the depression of the push button 5 is transmitted to the marginal portion 42 while gradually deforming the convex portion 41, the diameter of the marginal portion 42 is hardly deformed. The reason for this is that the marginal portion 42 extends circumferentially of the lower edge of the convex portion 41 without a break. That is, the actuation force exerted on the movable contact piece 4 is not relieved by deforming the marginal portion 42 but instead it is applied solely to the convex portion 41 to cause it flip over with a click.

Incidentally, an effort is under way to introduce long-stroke and tactile-response features into such a minute convex flip-over contact piece 4 whose diameter φ is about 4 mm. The long-stroke feature can be obtained by increasing the height of the convex portion 41. To increase only the height of the convex portion 41, with the diameter of the movable contact piece 4 limited to a predetermined value, means to increase the inclination of the convex portion 41 --this inevitably increases the structural rigidity of the convex portion 41 and requires an increase in the force necessary for it to flip over at the dead point. To exceed the increased force for the flipping-over operation of the convex portion 41, the actuation force to be exerted on the push button 5 must be increased, giving rise to the problem of impaired operability though the stroke increases. The increase in the actuation force is particularly important when the miniature convex flip-over contact piece 4 about 4 mm in diameter φ is made long-stroke.

### SUMMARY OF THE INVENTION

It is therefore an object of the present invention to provide a low-profile but long-stroke-type, convex flip-over contact piece for a tactile switch which has as small a diameter as 4 mm or so but requires relatively small actuation force and provides good tactile response.

The low-profile, flip-over contact piece according to the present invention comprises:

a convex portion made from a substantially circular springy metal sheet;

a plurality of circumferentially-spaced-apart marginal portions extending from the marginal edge of the convex portion in the direction opposite to the direction of convexity; and

a plurality of circumferentially-spaced-apart extensions of the convex portion defined between the plurality of marginal portions.

### BRIEF DESCRIPTION OF THE DRAWINGS

FIG. 1A is a sectional view of a conventional tactile switch;

FIG. 1B is a magnified view of its principal part;

FIG. 2 is its exploded perspective view;

FIG. 3A a plan view illustrating an embodiment of the low-profile, flip-over contact piece according to the present invention;

FIG. 3B is a sectional view taken along the line 3B-3B in FIG. 3A;

FIG. 3C is a sectional view taken along the line 3C-3C in FIG. 3A;

FIG. 3D is its perspective view;

FIG. 4A is a sectional view of the contact piece of the present invention in its non-pressed state;

FIG. 4B is a sectional view of the contact piece of the present invention in its pressed state; and

FIG. 5 is a plan view illustrating another embodiment of the contact piece according to the present invention.

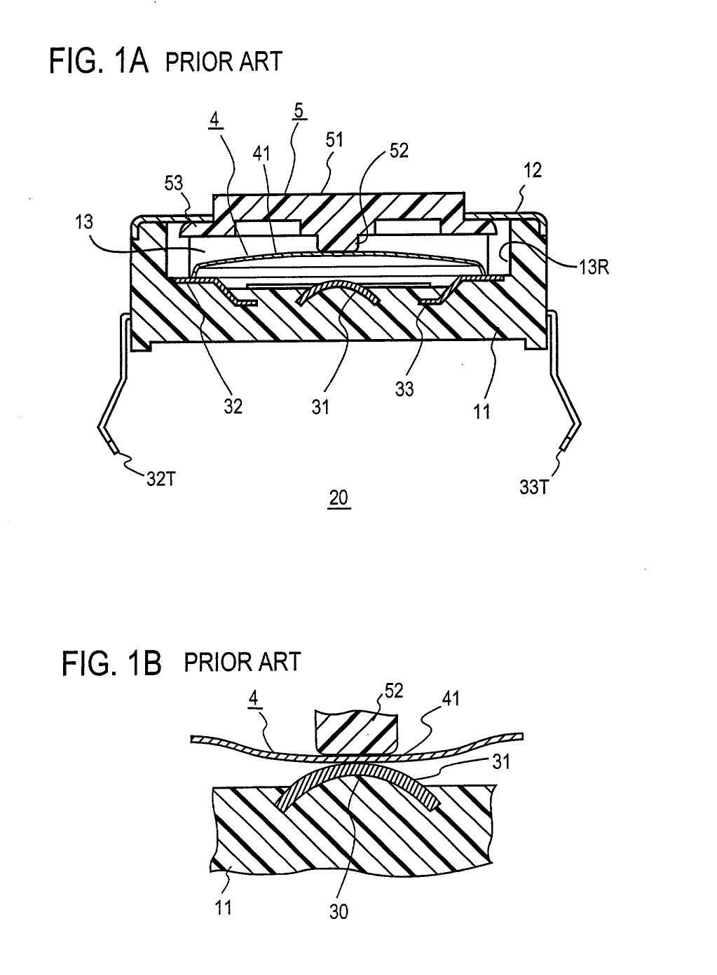

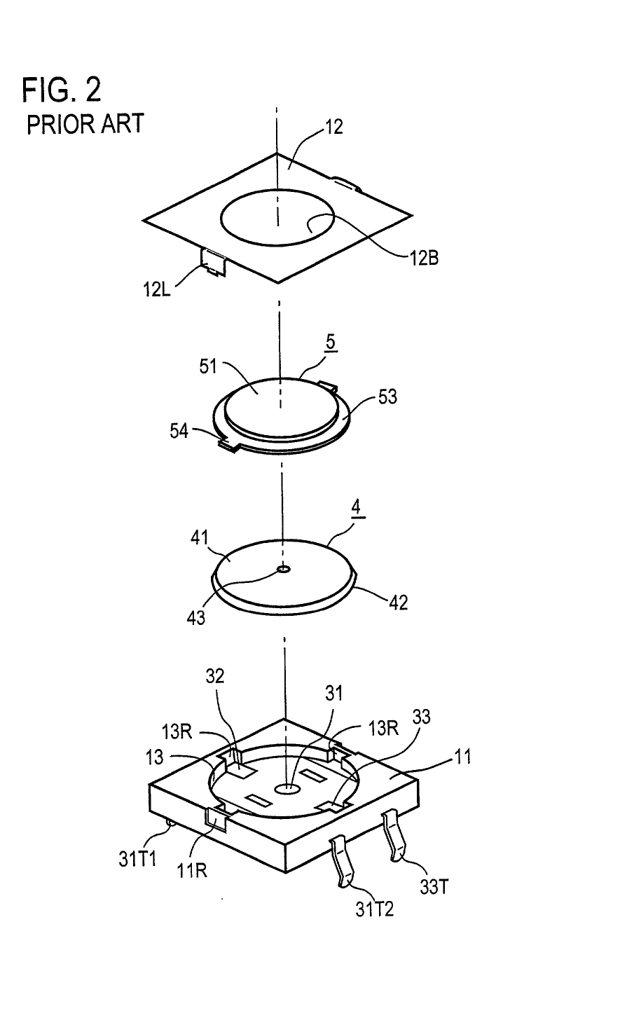

### DETAILED DESCRIPTION OF THE PREFERRED EMBODIMENTS

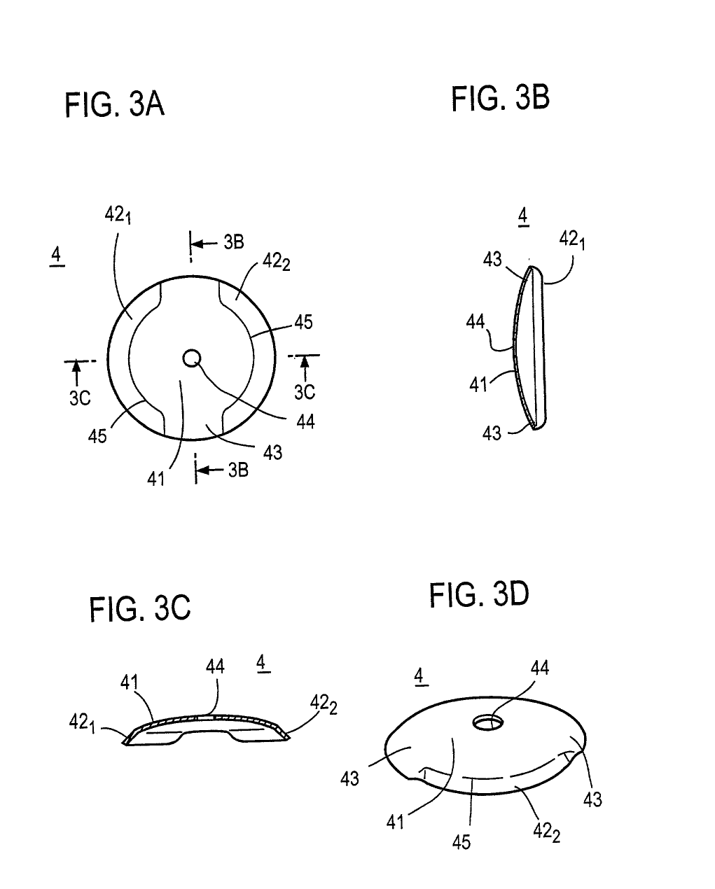

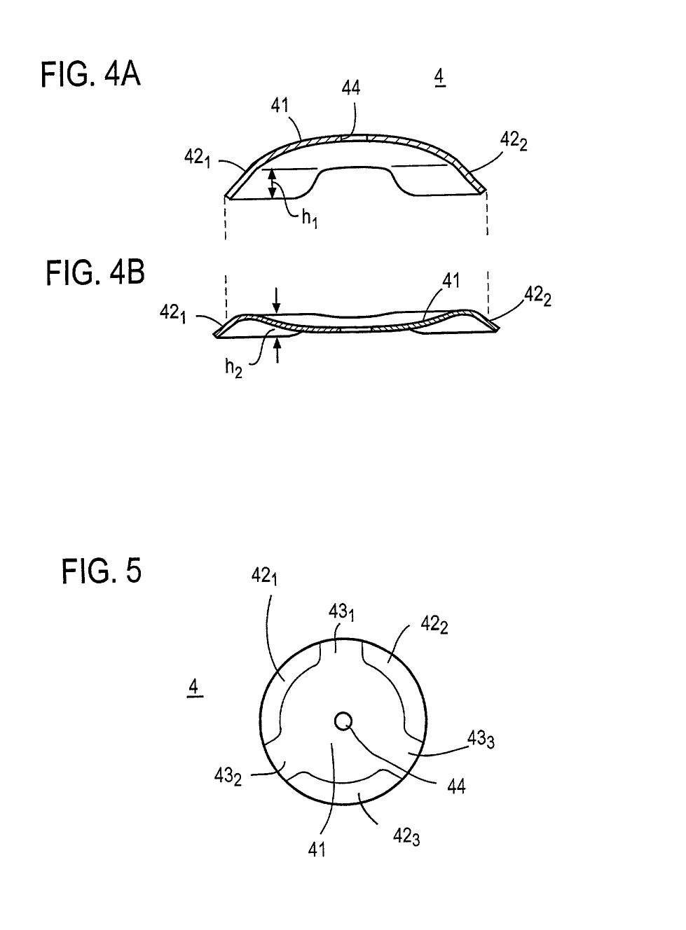

Referring first to FIGS. 3A to 3B and 4, an embodiment of the low-profile, flip-over contact piece according to the present invention will be described. The parts corresponding to those in the afore-mentioned prior art example are identified by the same reference numerals.

FIGS. 3A to 3D are explanatory of an embodiment in which the downturned marginal portion 42 is divided circumferentially thereof into two. The low-profile, convex flip-over contact piece, or movable contact piece 4 is formed by press working a highly springy metal sheet into dome or convex form and stamping the convex metal sheet into the disk shape to form the dome or convex portion 41. This is followed by press working a pair of diametrically opposite marginal portions of the dome portion 41 downwardly (in the direction opposite to the direction of convexity of the dome portion 41) to form marginal portions 42₁ and 42₂. The boundaries between the dome portion 41 and the marginal portions 42₁ and 42₂ are press worked into arcuate ridges 45. Between the opposite ends of the marginal portions 42₁ and 42₂ are formed dome extensions 43 left unpressed downwardly. Accordingly, the extensions 43 have their top surfaces extended from the top surface of the dome portion 41 with the same radius of curvature.

When the movable contact piece 4 is placed on a flat surface, the lower edges of the marginal portions 42₁ and 42₂ contact the flat surface but the dome extensions 43 remain slightly above the flat surface. Reference numeral 44 denotes a center aperture. With the illustrated structure, when pressed down at its center from above, the movable contact piece 4 is robust against a bending force acting about the direction of its diameter passing through the marginal portions 42₁ and 42₂ but is resiliently bent relatively easily by a bending force acting about the direction of its diameter passing through the extensions 43.

In this instance, upon being pressed down at its top through the push button 5, the dome portion 41 begins to be gradually deformed intermediate between the two arcuate ridges 45, and upon passage through the dead point, the dome portion 41 snappingly flips over along the arcuate ridges 45. Since the contact piece 4 is formed so that the extensions 43 between the marginal portions 42₁ and 42₂ are readily bent the instant of flipping-over action of the dome portion 41, the minimum actuation force therefor decreases, facilitating the flipping-over action accordingly.

In FIG. 4A, when the contact piece 4 is pressed at its center, the dome portion 41 is bent about the line 3B-3B, and as shown in FIG. 4B, the marginal portions 42₁ and 42₂ are pushed radially outwardly and the dome portion 41 is forced to spread flat. As a result, the height h₁ of each of the marginal portions 42₁ and 42₂ is reduced to h₂. The downward stroke for depressing the push button 5 increases by the decrease in the height from h₁ to h₂. That is, in the present invention, the downward stroke of the push button 5 for the flipping-over action of the dome portion 41 can be increased corresponding to the decrease (h₁-h₂) in the height of each marginal portion 42, as compared with the downward stroke of the push button needed in the prior art example in which the marginal portion 42 extends along the entire circumference of the lower edge of the dome portion 41.

As described above, the downward stroke of the push button 5 from the start of its depression to the flipping-over action of the dome portion 4 is equivalent to the sum of the stroke corresponding to the flipping-over action of the dome portion 41 and the stroke corresponding to the decrease in the height of the marginal portion 42.

FIG. 5 illustrates another embodiment of the low-profile, flip-over contact piece 4 according to the present invention, in which the marginal portion of the dome portion 41 is divided into three marginal portions 42₁, 42₂ and 42₃.

In this embodiment, too, the pressure applied to the center of the dome portion 41 pushes marginal portions 42₁, 42₂ and 42₃ radially outwardly. This reduces the actuation force at the time of the flipping-over action of the dome portion 41 to provide increased tactile feedback, while at the same time, reduces the heights of the marginal portions 42₁, 42₂ and 43₃ to increase the downward stroke of the push button accordingly.

### EFFECT OF THE INVENTION

As described above, according to the present invention, the dome portion 41 has the same construction as in the prior art example, but the downward stroke of the push button 5 can be set larger than in the prior art in anticipation of the decrease in the height of the marginal portions 42 at the time of the flipping-over action of the dome portion 41. Further, the actuation force for the flipping-over action can be reduced accordingly. Hence, the present invention offers a miniature low-profile, flip-over contact piece which is as small as about 4 mm in diameter but requires a smaller actuation force and provides good tactile response which are difficult to achieve with the prior art.

What is claimed is:

1. A low-profile, flip-over contact piece comprising:
a dome portion made from a substantially circular springy metal sheet;
a plurality of circumferentially-spaced-apart marginal portions extending from the marginal edge of said dome portion in the direction opposite to the direction of its convexity; and
a plurality of circumferentially-spaced-apart extensions of said dome portion defined between said plurality of marginal portions.

2. The contact piece of claim 1, wherein arcuate ridges are formed at the boundaries between said dome portion and said plurality of marginal portions.

3. The contact piece of claim 1, wherein the number of said plurality of marginal portions is two.

4. The contact piece of claim 2, wherein the number of said plurality of marginal portions is two.

5. The contact piece of claim 1, wherein the number of said plurality of marginal portions is three.

6. The contact piece of claim 2, wherein the number of said plurality of marginal portions is three.
